(19) United States
(12) Patent Application Publication
(10) Pub. No.: US 2002/0173316 A1
(43) Pub. Date: Nov. 21, 2002

(54) Method and system for preventing access overload in mobile phone systems

(75) Inventors: Ke-Chi Jang, Plano, TX (US); Chung-Ching Wang, Plano, TX (US)

Correspondence Address: HAYNES AND BOONE, LLP, 901 MAIN STREET, SUITE 3100, DALLAS, TX, 75202, US

(73) Assignee: Nortel Networks Limited, St. Laurent, QC (CA)

(21) Appl. No.: 10/025,590

(22) Filed: Dec. 18, 2001

Related U.S. Application Data
(60) Provisional application No. 60/268,768, filed on Feb. 12, 2001.

(51) Int. Cl. H04Q 7/20

(52) U.S. Cl. 455/453; 455/452

(57) ABSTRACT

There is provided, a system and method to limit access to the network during overload conditions by transmitting access control signals to the mobile terminals, where the messages specify a subset of the mobile terminals which will be prevented from accessing the network. Thus, allowing the remaining terminals to access the network.

### CROSS REFERENCE TO RELATED APPLICATIONS

This application claims the benefit of U.S. Provisional Application No. 60/268,768, filed Feb. 12, 2001, the entire contents of which are incorporated by reference.

### TECHNICAL FIELD

The invention relates generally to cellular communication networks and, particularly, to a method and system for controlling access in communication networks during periods of overload conditions.

### BACKGROUND INFORMATION

During situations where large groups of people gather, such as in stadium events, mobile phone networks may be overloaded. In other words, due to a large number of users gathering in relatively close proximity, the demand for mobile phone services may often exceed the capacity of the mobile network. A similar situation exists during emergency situations when a large number of users may attempt to place calls within a relatively short time. For purposes of this Application, such conditions will be referred to as “overload conditions”. The overload condition may occur in the “air wave” or radio link portion of the network, as in the case of a stadium event. On the other hand, the overload condition could also occur in the land-based portion of the network, as in the case of a major emergency, where a large number of calls are being made from over a large area.

Previous methods to control access to networks during overload conditions used a methodology that randomly allows access to the land-based network. However, these methods have been thwarted by mobile users manually repeating access requests or by using an auto redial feature to request access. Additionally, when mobile users repeatedly attempt to access the land-based portion of the network, an overload situation may be created in the radio link portion of the network.

What is needed is a system and method that prevents mobile users (or a group of mobile users) from sending call requests during overload situations, yet allows emergency calls to go through.

### SUMMARY OF THE INVENTION

The previously mentioned needs are fulfilled with the present invention. Accordingly, there is provided, a system and method to manage access to the network by transmitting access control signals to the mobile terminals, where the messages specify a subset of the mobile terminals which will be prevented from accessing the network. Thus, allowing the remaining terminals to access the network.

These and other features, and advantages, will be more clearly understood from the following detailed description taken in conjunction with the accompanying drawings. It is important to note the drawings are not intended to represent the only form of the invention.

### BRIEF DESCRIPTION OF THE DRAWINGS

FIG. 1 is an exemplary wireless communications system and network for implementing various aspects of one embodiment of the present invention.

FIG. 2 is a schematic diagram of an exemplary mobile terminal for implementing various aspects of one embodiment of the present invention.

FIG. 3 is a flow diagram illustrating one embodiment of a method used for controlling network access.

FIG. 4 is a flow diagram illustrating one embodiment of a method used for controlling network access.

FIG. 5 is a flow diagram illustrating one embodiment of a method used for controlling network access.

### DETAILED DESCRIPTION OF THE INVENTION

The present invention provides a unique method and system for limiting or “controlling” access in communication networks during overload conditions. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry or mechanisms used to control the rotation of the various elements described herein are omitted, as such control circuits are within the skills of persons of ordinary skill in the relevant art.

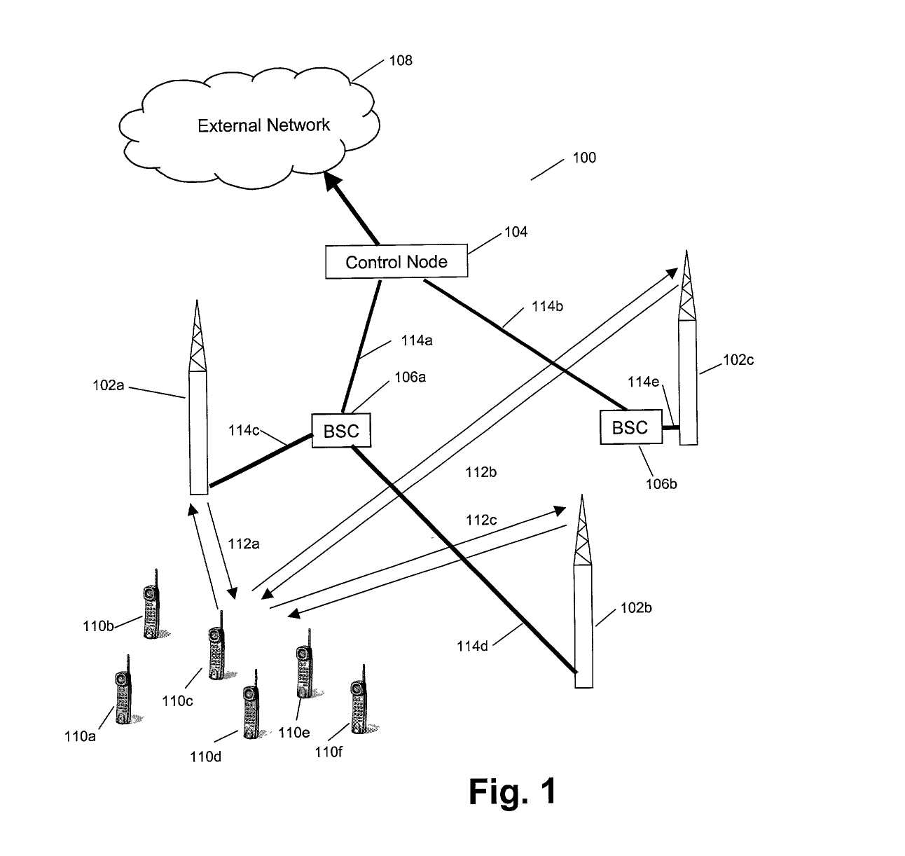

Referring to FIG. 1, an exemplary wireless communications system and network 100 is shown for implementing various embodiments of the present invention. For the sake of example, the network/system 100 utilizes CDMA modulation techniques based on the TIA/EIA/IS-2000, Mobile Station-Base Station compatibility Standard for Dual-Mode Wideband Spread Spectrum Cellular System (hereinafter “IS-2000”). It should be apparent to one of ordinary skill in the art that the present invention can be equally applicable to similar wireless communication systems employing other CDMA techniques (e.g., ones based on the ANSI J 008 standard) or those employing other types of multiple access techniques.

The service area for the network 100 is divided into cells, each of which may be further divided into sectors. Each cell is served by a single base station transceiver subsystem (“BTS”), for instance, BTSs 102a, 102b, and 102c. The BTSs 102a-102b are controlled by a base station controller (“BSC”) 106a via the appropriate hardware links. Similarly, the BTS 102c is in communication with and controlled by a BSC 106b. The BSCs 106a-106b are in communication with a control node 104.

In some embodiments, the control node 104 may be a mobile switching center (“MSC”). The MSC includes interface and processing circuitry for providing system control to the various nodes. In other embodiments, such control may be distributed among various nodes in the network 100. 3G networks might use a packet data serving node (“PDSN”). A PDSN node performs two basic functions: (1) it exchanges packets with mobile terminals over the radio network, and (2) it exchanges packets with other IP networks, such as the Internet. Thus, the use of a PDSN allows additional data and voice services to be provided to the wireless user.

In embodiments using a MSC, the control node 104 controls the routing of telephone calls to and from an external network 108 to numerous mobile stations or terminals, which are represented in FIG. 1 as mobile terminals 110a-110f. The external network 108 may be a public switched telephone network (“PSTN”) or an IP network, such as the Internet. In embodiments using a PDSN, the control node 104 exchanges packets of information with the mobile terminals 110a-110f with other IP networks, such as the Internet. Some embodiments could also use a combination of an MSC for voice communications and a PDSN for data communications.

The mobile terminals 110a-110f establish communication with the external network 108 by establishing radio frequency (“RF”) links 112a-112c with a nearby BTS. The RF links 112a-112c may transfer information over a variety of communication channels. Such channels include traffic channels for transmitting voice (or data) signals, and pilot channels for transmitting pilot signals, wherein the pilot signals are used primarily for power measurement (to initiate call establishment, handoffs, etc.) and to allow the mobile terminals to perform coherent demodulation of traffic channel signals. Traffic channels and pilot channels are well-known in the art, and the manner in which these (and other) channels are defined depends on the specific implementation of the wireless communication system.

The control node 104 communicates with the BSCs 106a-106b through links 114a and 114b, respectively. The links 114a and 114b may be dedicated telephone lines, optical fiber links, microwave communication links, or other types of links well known in the art. Similarly, the BSCs 106a and 106b communicate with the BTSs 102a, 102b, and 102c by links 114c, 114d, and 114e, respectively.

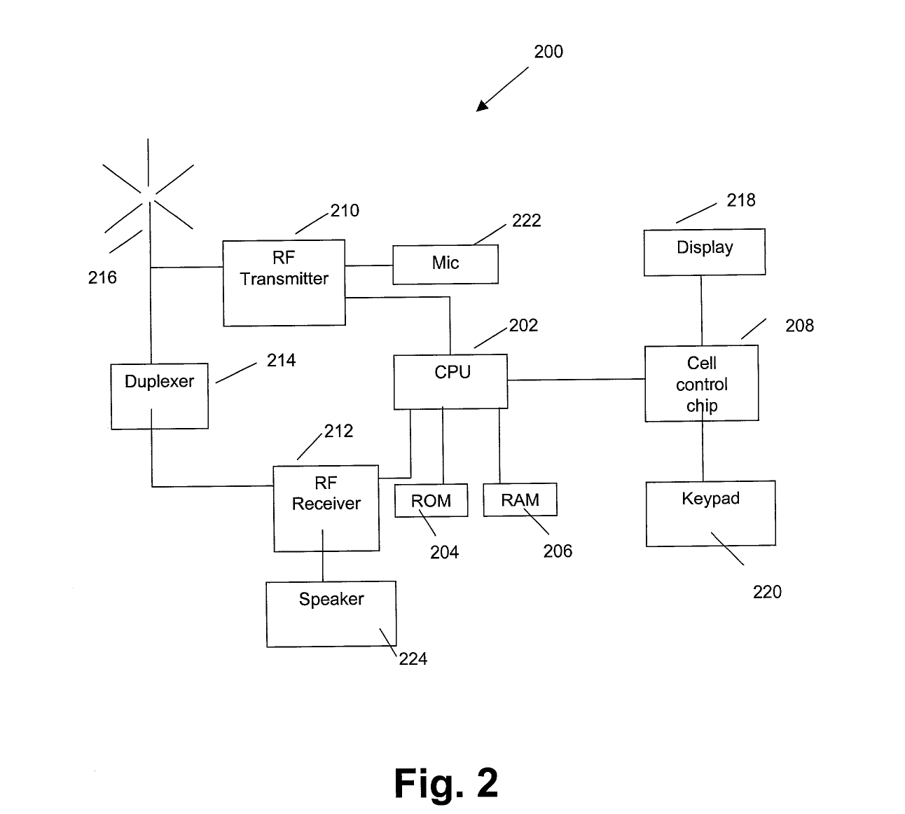

Turning now to FIG. 2, there is a schematic diagram of an exemplary mobile terminal 200 for implementing various aspects of the present invention. The heart of the mobile terminal 200 is a central processing unit (“CPU”) 202. The CPU 202 receives instructions from a memory device, such as a read-only memory (“ROM”) 204. There may also be additional memory devices, such as a random access memory (“RAM”) 206. The RAM 206 is used for storing temporary data, such as user-definable numbers or network variable values and flags. The CPU 202 is also in communication with a cellular control chip 208, which retains the cellular identification number and controls operational frequencies for an RF transmitter 210 and an RF receiver 212. The RF transmitter 210 and the RF receiver 212 are coupled by a duplexer 214 to an antenna 216. The CPU 202 may display output information on a display 218. There is also a keypad 220 with a dual tone multi-frequency (“DTMF”) generator which allows calls to be made.

Thus, a user may dial a number by pressing the keypad 220, which stores the number into the RAM 206. Upon another keyboard command, such as the “send” command, the number from the RAM 206 is sent via the radio transmitter to a BTS so that a session may be established. Once a call session is established, the user speaks into a microphone 222, which converts the user's acoustical energy to electric signals. Conversely, a speaker 224 converts electrical voice signals received from the RF receiver 212 into acoustic energy so that the user may carry on a conversation.

Exemplary Method

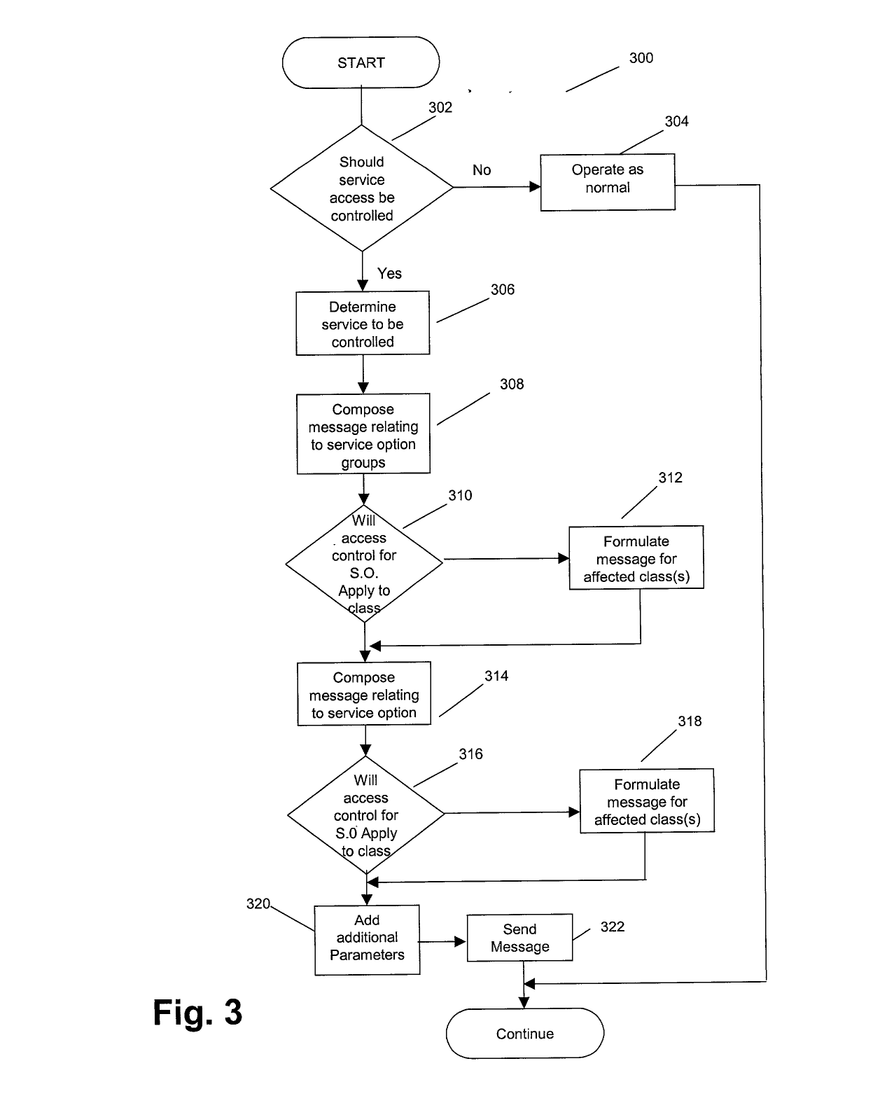

Referring now to FIG. 3, a method 300 can be used for controlling network access during overload conditions. In the present example, the method operates according to CDMA protocol and may be performed at base station or BSC level. However, in some implementations, the method may be implemented at a controller which controls one or more BSCs. For purposes of this application, it will be assumed that the exemplary method is implemented at the BSC.

As discussed above, when a large number of users gather in relatively close proximity, the demand for mobile phone services may exceed the capacity of the mobile network. A similar situation exists during emergency situations when a large number of users attempt to place calls within a relatively short time. Once the BSC is made aware of the overload condition, the BSC begins to analyze the condition to determine the proper course of action. In step 302, the BSC determines if access to the network should be limited (i.e, should access control be implemented). If not, the operation of the network continues as normal (step 304). On the other hand, if control access is implemented, the BSC then decides on which “call type” or type of service to control. For purposes of this application, the term “service” includes “service options” and “service option groups.”

In CDMA 2000, service options for various voice and non-voice services are defined and specified independently. Currently, there more than 45 standard service options specified in CDMA 2000. As an example, some of the service options are GSM voice, ISDN interworking services, high speed packet data service, Group 3 facsimile, and packet data service.

Additionally, CDMA 2000 also supports “service option groups” which are distinguishable from “service options.” A service option group is a set of logically related service options. Currently, there are at least ten service option groups defined in CDMA 2000. Some of the service option groups include: voice services, digital facsimile services, analog facsimile services, packet data services, and location services.

There may be an additional need to control network access to a portion or subset of the mobile terminals using a particular service option or a service option group. Such control may be accomplished by dividing the service option or service option group into two or more classes. One basis for dividing the mobile terminals into classes is their unique identifying number.

Every mobile terminal has a unique identifying number. For instance, wireless phones have an International Mobile station Equipment Identity (“IMEI”) number, which is similar to a serial number. GSM phones also have a International Mobile Subscriber Identity (“IMSI”) number. The IMSI number is a 50-bit field and also identifies the phone's home country and carrier. Such numbers may be used as a means for dividing the mobile terminals into classes. For instance, every identifying number will end in a digit from 0 to 9. Thus, it is possible to divide the mobile terminals into ten classes based on the last digit of the unique identifying number. It is also possible to divide the mobile terminals into five classes based on the last digit. For instance, all phones having unique identifying numbers ending in 0 and 1 could assigned to one class. Similarly, all phones having unique identifying numbers ending in 2 and 3 could assigned to another class, and so on. Under a five class system, controlling network access to any one class would deny network access to approximately twenty percent of the mobile terminals.

Referring back to FIG. 3, once the decision has been made to implement access control (i.e., deny network services) (in step 302), in step 306, the control unit decides which services to limit based on system implementation and predetermined criteria. For instance, if the overload condition is light to moderate, a decision might be made to control or limit access to all data services, but allow voice services to continue. In another situation, the control unit might limit access to all digital facsimile services, (which would include Group 3 facsimile services (9.6 kps) in addition to other facsimile speeds).

There may be situations, however, where the denial of services should be based on individual service options and not service option groups. For instance, rather than denying all fax services, the control unit may decide to only deny Group 3 Facsimile services sending at 14.4 kps, while allowing other types of fax services (i.e., fax services running at 9.6 kps). Finally, the BSC could also limit access to a class or classes within a particular service option or service option group. For example, if an overload condition were occurring at a stadium event, denying service for fax or data transmissions would have little effect because the majority of the overload would be from voice services. In such a situation, it may be prudent to limit access to an individual class or several classes within a particular service option or service option group.

Once the BSC has identified the service option(s), service option group(s) and class(s) of service which will be controlled, the BSC may compose a message to broadcast to the mobile terminals (i.e., an “access control message”). Thus, in step 308, the BSC composes a portion of the message controlling access to service option groups. In step 310, a check is made to determine whether access will be further divided based on class. If yes, then in step 312, the classes to be limited are specifically indicated or “added” to the message.

In step 314, the BSC composes a portion of the message controlling access to any affected service options. In step 316, a check is made to determine whether affected subset will be further divided based on class. If yes, then in step 318, the affected classes are specifically added to the message. As will be discussed later, other parameters may also be added to the message in step 320.

After the access control message is composed, in step 322 it is broadcasted to the mobile terminals. In CDMA networks, such access control messages may be sent to the mobile terminals every 1.28 seconds. Although the process 300 could be repeated every time a message is sent, it is anticipated that the message will be repeated for a predetermined amount of time (or a predetermined number of messages), then new services or classes will be selected for access control. For instance, assume that two classes were initially selected for access control (i.e., blocking of access) for the service option group of voice services. The access control signal specifying this service option group and these two classes could be continuously repeated 20 times (or 24 seconds). After that time period, a new message would be sent indicating that other classes are now selected for access control. Thus, a series of access control messages could be repeated at predetermined intervals to insure that no class would be denied access for an unfair length of time.

To illustrate the process 300, an example message will now be discussed. The example message will be discussed in terms of parameter values or data fields. The CDMA 2000 standard supports the use of assigned parameter values. Thus, the message sent in step 322 can be sent in the form of a set of parameters or field values. In this illustrative example, a parameter named “NUM_ACC_SO_GRP” is used to specify the number of service option groups slated for access control. Similarly, the parameter “NUM_ACCT_SO” is used to specify the number of individual service options slated for access control. Thus, if the message has a value of “3” in the “NUM_ACCT_SO_GRP”, a mobile terminal receiving the message will know that three service option groups will be affected by access control. Similarly, if the message has a value of “2” for the “NUM_ACCT_SO” variable, the mobile terminal will know that two individual service options will be affected by access control. In this illustrative example, a single message could send access control parameters for up to 16 different service options and 8 different service option groups.

By mapping the service option groups to a list of decimal values, the message can specify which service option groups will be affected by simply sending a number which corresponds to a particular service option group. A complete mapping of decimal values to service options groups can be found in Table 3.3-1 of the publication 3GPP2 C.R1001-3, Administration of Parameter Value Assignments for CDMA2000 Spread Spectrum Standards, version 2.0, May 11, 2001, by 3^{rd} Generation Partnership Project 2, (“3GPP2 C.R1001-3”) which is hereby incorporated by reference in its entirety. A portion of this table is reproduced below as Table 1:

TABLE 1

| Service Option | Type of Service in the |
|---|---|
| Group (Decimal) | Group |
| 0 | Voice Services |
| 1 | Low Speed Async Data |
| | Services |
| 2 | Digital Facsimile Services |
| 3 | Analog Facsimile Services |
| 4 | Non-CDPD Packet Data |
| | Services |
| 5 | CDPD Packet Data Services |
| 6 | SMS Services |
| 7 | OTAPA Services |
| 8 | Location Services |

Using a mapping table, such as Table 1, the service option groups slated for access control can be specified by sending the decimal parameter values. For instance, a parameter named “ACCT_SO_GRP” could be used to specify which service option group should be included for access control. If this parameter has a decimal value of 0, the mobile terminals know that voice services are slated for access control. Similarly, if this parameter had a value of 1, low speed async data services would be slated for access control. Thus, the BSC could formulate a portion of the message dealing with service option groups by specify the parameter NUM_ACCT_SO_GRP to specify the number of service option groups affected and the parameter ACCT_SO_GRP, which would tell the mobile terminals which specific service option groups are affected.

In a similar manner, the service options can be specified and mapped to a list of decimal values. A complete mapping of decimal values to service options can be found in Table 3.1-1 of the publication 3GPP2 C.R1001-3. A portion of this table is reproduced below as Table 2:

TABLE 2

| Service Option | Designated Use/Type of |
|---|---|
| (Decimal) | Service |
| 1 | Basic Variable Rate Voice |
| | Service |
| 2 | Mobile Station Loopback |
| 3 | Enhanced Variable Rate |
| | Voice Service |
| 4 | Asynchronous Data Service |
| 5 | Group 3 Facsimile |
| 6 | etc. |

Using a mapping table, such as Table 2, the service options slated for access control can be specified by sending the decimal parameter values. For instance, a parameter named “ACCT_SO” (i.e., Access Control based on Call Type Service Option) can be used to specify which service option should be included for access control. For instance, when this parameter has a decimal value of 5, the mobile terminals know that Group 3 facsimile services are slated for access control. Similarly, if this parameter has a decimal value of 3, enhanced variable rate voice would be slated for access control. Thus, the BSC could formulate a portion of the message dealing with service options by specify the parameter NUM_ACCT_SO to specify the number of service option groups affected and the parameter ACCT_SO, which would tell the mobile terminals which service options are affected.

The classes slated for access control may also be communicated to the mobile terminals by using parameters and subfields. Continuing with the illustrative example, the classes slated for access control can be specified by sending parameters such as “ACCT_AOC_BITMAP1” and “ACCT_AOC_BITMAP2.” The parameter ACCT_AOC_BITMAP1 may be used for service options, and the parameter ACCT_AOC_BITMAP2 may be used for service option groups. In this illustrative example, these parameters contain sub-fields whose values are defined as in Table 3:

TABLE 3

| | Length | |
|---|---|---|
| Subfield | (bits) | Subfield Description |
| ACCOLC_0_1 | 1 | Access overload |
| | | classes 0 and 1 |
| ACCOLC_2_3 | 1 | Access overload |
| | | classes 2 and 3 |
| ACCOLC_4_5 | 1 | Access overload |
| | | classes 4 and 5 |
| ACCOLC_6_7 | 1 | Access overload |
| | | classes 6 and 7 |
| ACCOLC_8_9 | 1 | Access overload |
| | | classes 8 and 9 |

The subfields are set to ‘1’ to indicate that mobile terminals having the corresponding access overload class are not permitted to perform access attempts using the associated service option or service option group. For instance, if the BSC wanted to limit all voice services in classes 2 and 5 (i.e., mobile phones whose identification numbers end in “2”, “3”, “8”, and “9”), the BSC would send out a parameter ACCT_SO_GRP with a value of “0” to indicate the service option group (i.e., voice services) is slated for access control. The BSC would also send the associated parameter of ACCT_AOC_BITMAP2, where the subfields would be set to the following:

TABLE 4

| Subfield | Value |
|---|---|
| ACCOLC_0_1 | 0 |
| ACCOLC_2_3 | 1 |
| ACCOLC_4_5 | 0 |
| ACCOLC_6_7 | 0 |
| ACCOLC_8_9 | 1 |

Upon receiving such a message, a mobile terminal compares the last digit of is unique identity number to subfields to determine if it is affected by the message. For instance, if a mobile terminal's unique identity number ends in “2”, it would know that it cannot send messages requesting voice services to the network. On the other hand, if the mobile terminal's unique identity number ends in “5,” it could safely ignore the portion of the message relating to ACCLC_2_3 because the mobile terminal is not a member of the affected class.

As indicated in step 320 (FIG. 3), other control parameters could also be sent in the message. For instance, a variable “ACCT_INCL_EMG” could be used to control access for emergency calls. The BSC could set this field to ‘0’ if the mobile terminals are not to apply access control a call that is recognized by the mobile terminal to be an emergency call. Otherwise, the BSC would set this field to ‘1’, which will apply access control to emergency calls. As an example, if the user dialed “911” and variable “ACCT_INCL_EMG” is set to “0”, then an affected mobile terminal would attempt to connect to the network. If, on the other hand, the variable “ACCT_INCL_EMG” is set to “1”, the affected mobile terminal would not attempt the connection.

The Mobile Terminals

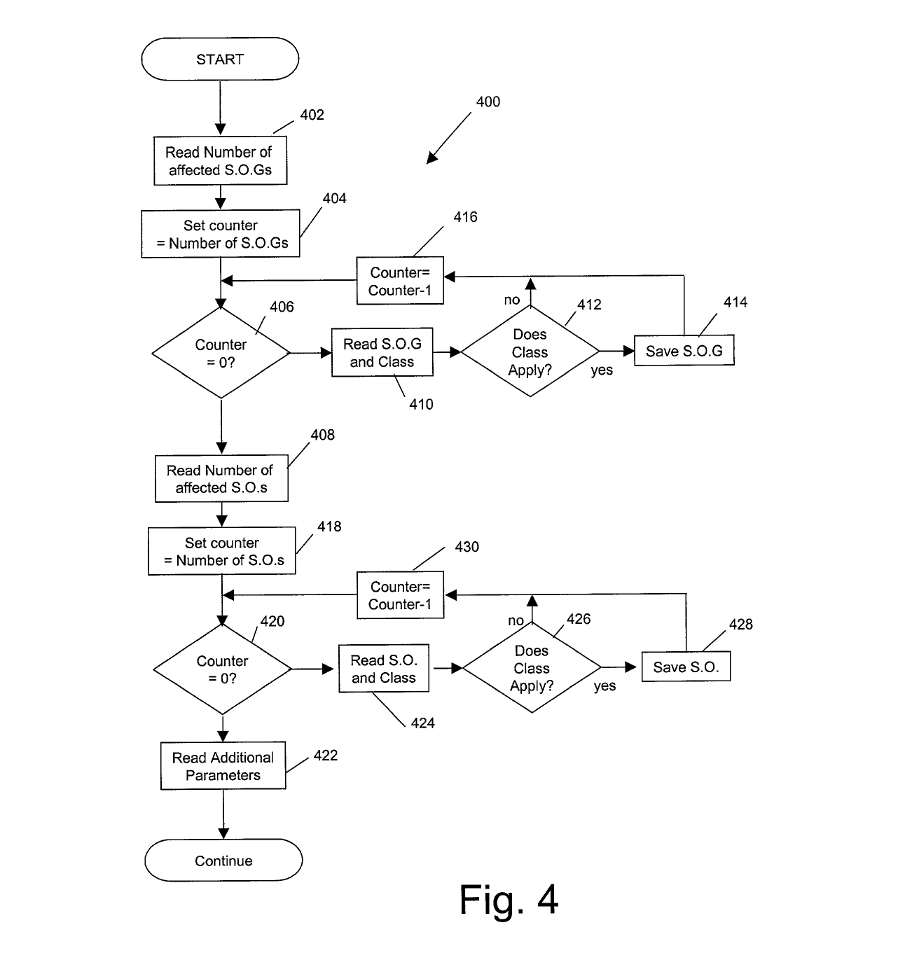

After the access control message has been composed, it is sent by the BSC to the mobile users within range. As explained above, the access control message includes a number of parameter values, including parameter values indicating the number of service options and service option groups to be affected by access control. After the mobile terminal receives the access control message, the mobile terminal may determine if it is a member of the affected class (or subset) by reading the parameter values. If the mobile terminal is a member of the affected class, it sets internal flags or otherwise stores this information for later use. However, if the mobile terminal is not a member of the affected class, the mobile terminal ignores the information. FIG. 4 shows one example embodiment of a process 400 which may be performed by the mobile terminals to analyze the access control message.

In step 402, the mobile terminal reads a parameter specifying the number of affected service option groups. Using the illustrative example discussed above, this would be the parameter NUM_ACCT_SO_GRP. In step 404, the mobile terminal sets a counter equal to the parameter value. In step 406, the mobile terminal checks to see if the counter has a value of zero. If the counter is zero, the process proceeds to step 408 (i.e., there are no more service option group parameters to read). If the counter value is not zero (i.e., there are additional service option group parameters to read), the process continues to step 410. In step 410, a service option group parameter is read along with its associated classes. In the illustrative example, this would be the parameter ACCT_SO_GRP and its subfields ACCOLC_0_1 through ACCOLC_8_9.

In step 412, the mobile terminal compares the last digit of unique identity number to the subfields associated with the parameter to determine if it is a member of the affected class. If the mobile terminal is a member, then either a flag is set or the parameter value is saved in memory for later use (step 414). If the mobile terminal is not affected, the mobile terminal ignores the parameter value and the process continues to step 416. To illustrate, assume the mobile terminal has an IMEI number of 123456-78-901234-5. The mobile terminal's last digit is “5.” Therefore, the mobile terminal checks the value of the sub-field “ACCOLC_4_5” to determine if it is set to “1” or “0.” If the value of “ACCOLC_4_5” is set to “1,” access control will apply to the mobile terminal and the parameter value is saved (or a 1corresponding flag is set) in memory for later use (step 428). If the mobile terminal is not affected, the mobile terminal ignores the parameter value and the process continues to step 416. In step 416, the counter value is reduced by one and the process control loops back to step 406.

Turning back to step 408. In step 408 the mobile terminal reads a parameter specifying the number of affected service options. Using the illustrative example, this would be the parameter NUM_ACCT_SO. In step 418, the mobile terminal sets a counter equal to the number of affected service options. In step 420, the mobile terminal checks to see if the counter has a value of zero, if it does the process proceeds to step 422, where additional parameters may be read.

If the counter value is not zero, on the other hand, the process continues to step 424. In step 424, a service option parameter is read along with its associated classes. Using the illustrative example, this would be in the form of the parameter ACCT_SO and its subfields ACCOLC_0_1 through ACCOLC_8_9.

In step 426, the mobile terminal compares the last digit of its unique identity number to the subfields associated with the parameter to determine if it is a member of the affected class. In step 430, the counter value is reduced by one and the process control loops back to step 420. At the end of this loop cycle, other control parameters (e.g. emergency parameters) could be read in step 422.

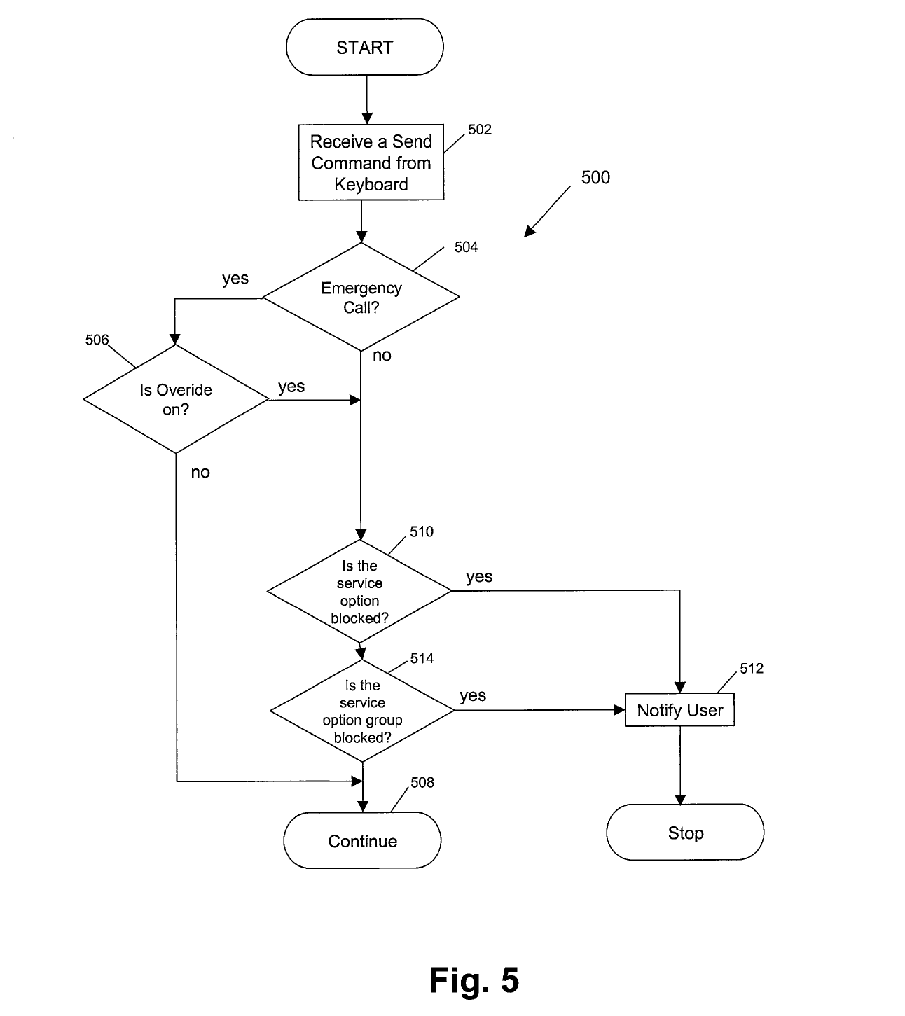

FIG. 5 illustrates a method 500 which might be performed by the mobile terminal to check the status of the access control parameters before attempting to access the network. At step 502, a send command is received from the mobile terminal's keyboard or another input device. In step 504, the mobile terminal determines whether the call made is an emergency call (e.g., “911”). If it is an emergency call, the process flows to step 506 where a determination is made as to whether emergency calls should be subject to access control. This determination may be made by checking an emergency parameter value. In the illustrative example, the emergency parameter could be “ACCT_INCL_EMG.” If this parameter is set to ‘0’ the mobile terminal will not apply access control, and the call will continue in a normal manner (step 508). On the other hand if this field is set to “1”, the mobile terminal will apply access control, and the process will continue to step 510.

In step 510, the mobile terminal checks its previously stored parameter values or flags to see if the service option associated with the send command is to be blocked. If it is, the process proceeds to step 512 where the user is notified that the call cannot proceed (e.g., the user hears a busy signal).

In step 514, the mobile terminal checks its previously stored parameter value or flags associated with the service option group associated with the send command is to be blocked. If the service option group is blocked, the process again proceeds to step 512 where the user is notified that the call cannot proceed. If not, the call proceeds to step 508 where the call proceeds as normal.

Implementation of one Embodiment in CDMA 2000

In one embodiment, the methods and procedures described above can be implemented as part of a standard, such as CDMA 2000. If implementing an embodiment in the CDMA 2000 standard, the following sections of the CDMA could be changed as follows:

1.1.2.2 CDMA Numeric Information [. . . ]

ACCT_{—INCL}_{—EMG}_{S}-Access Control based on Call Type (ACCT) applies to emergency calls indicator.

ACCT_{—SO}_{—LIST - Access Control based on Call Type (ACCT) enabled.}

ACCT_{—SO}_{—GRP}_{—LIST - Access Control based on Call Type (ACCT) enabled.[. . .]}

2.6.1.1 System Determination Substate [. . . ]

If the mobile station enters the System Determination Substate with an access denied indication, the mobile station shall set REDIRECTION_{S} to disabled. If NDSS_{—ORIGs is enabled, the mobile station shall set NDSS}_{—ORIGs to disabled and should indicate to the user that the call origination is canceled. The mobile station shall select a system in accordance with the custom system selection process (see} 2.6.1.1.1) and shall attempt to acquire the selected system (see 2.6.1.1.4).

If the mobile station enters the System Determination Substate with an ACCT blocked indication, the mobile station shall set REDIRECTION_{S} to disabled. If NDSS_{—ORIG}_{S} is enabled, the mobile station shall set NDSS_{—ORIG}_{S} to disabled. The mobile station shall select a system in accordance with the custom system selection process (see 2.6.1.1.1) and shall attempt to acquire the selected system (see 2.6.1.1.4). [. . .] 2.6.2.2.2 Access Parameters Message [. . .]

The mobile station shall store the persistence parameter number according to the following rule: If the mobile station's access overload class is in the range 0-9, set PSIST_{S equal to PSIST(}0-9)r; otherwise set PSIST_{S} equal

to PSIST(n)ᵣ, where n is equal to the mobile station access overload class.

The mobile station shall store the Access Control based on Call Type (ACCT) information as follows:

Set ACCT_SO_LIST to NULL.

Set ACCT_SO_GRP_LIST to NULL.

If ACCT_INCLᵣ is equal to ‘1’ and ACCOLCₚ is in the range 0 to 9, then the mobile station shall perform the following:

Set ACCT_INCL_EMGₛ to ACCT_INCL_EMGᵣ.

If ACCT_SO_INCLᵣ is equal to ‘1’, then for each ACCT_SOᵣ included in this message:

+ If ACCT_AOC_BITMAP_INCLᵣ is equal to ‘0’, or if ACCT_AOC_BITMAP_INCLᵣ is equal to ‘1’ and the bit in the associated ACCT AOC BITMAP1ᵣ corresponding to the mobile station's ACCOLCₚ (see Table 3.7.2.3.2.2-1) is equal to ‘1’, then add ACCT_SOᵣ to ACCT_SO_LIST.

If ACCT_SO_GRP_INCLᵣ is equal to ‘1’, then for each ACCT_SO_GRPᵣ included in this message:

+ If ACCT_AOC_BITMAP_INCLᵣ is equal to ‘0’, or if ACCT_AOC_BITMAP_INCLᵣ is equal to ‘1’ and the bit in the associated ACCT_AOC_BITMAP2ᵣ corresponding to the mobile station's ACCOLCₚ (see Table 3.7.2.3.2.2-1) is equal to ‘1’, then add ACCT_SO_GRPᵣ to ACCT_SO_GRP_LIST.

[ . . . ]

2.6.2.2.15 Enhanced Access Parameters Message

[ . . . ]

Persistence related parameters:

If PSIST_PARMS_INCL is equal to ‘1’, store the following:

[ . . . ]

If PSIST_PARMS_INCLᵣ is equal to ‘0’, store the following:

[ . . . ]

The mobile station shall store the Access Control based on Call Type (ACCT) information as follows:

Set ACCT_SO_LIST to NULL.

Set ACCT_SO_GRP_LIST to NULL.

If ACCT_INCLᵣ is equal to ‘1’ and ACCOLCₚ is in the range 0 to 9, then the mobile station shall perform the following:

+ Set ACCT_INCL_EMGₛ to ACCT_INCL_EMGᵣ.

+ If ACCT_SO_INCLᵣ is equal to ‘1’, then for each ACCT_SOᵣ included in this message:

If ACCT_AOC_BITMAP_INCLᵣ is equal to ‘0’, or if ACCT_AOC_BITMAP_INCLᵣ is equal to ‘1’ and the bit in the associated ACCT_AOC_BITMAP1ᵣ corresponding to the mobile station's ACCOLCₚ (see Table 3.7.2.3.2.2-1) is equal to ‘1’, then add ACCT_SOᵣ to ACCT_SO_LIST.

+ If ACCT_SO_GRP_INCLᵣ is equal to ‘1’, then for each ACCT_SO_GRPᵣ included in this message:

If ACCT_AOC_BITMAP_INCLᵣ is equal to ‘0’, or if ACCT_AOC_BITMAP_INCLᵣ is equal to ‘1’ and the bit in the associated ACCT_AOC_BITMAP2ᵣ corresponding to the mobile station's ACCOLCₚ (see Table 3.7.2.3.2.2-1) is equal to ‘1’, then add ACCT_SO_GRPᵣ to ACCT_SO_GRP_LIST.

[ . . . ]

2.6.3.5 Mobile Station Origination Attempt Substate

[ . . . ]

Upon entering the Mobile Station Origination Attempt Substate, the mobile station shall set RLGAIN_ADJₛ to ‘0000’ and perform the following:

The mobile station shall exit the Mobile Station Origination Attempt Substate, shall enter either the Mobile Station Idle State or the System Determination Substate with an ACCT blocked indication, and should indicate to the user that the call has terminated if all of the following conditions are true:

P_REV_IN_USEₛ is greater than six,

ACCT_INCL_EMGₛ is equal to ‘1’ or the mobile station determines that the call is not an emergency call,

ACCT is enabled for the requested service option number, due to either of the following two conditions:

+ the requested service option number is equal to an ACCT_SO entry in ACCT_SO_LIST and the corresponding ACCT_ENABLED entry is equal to ‘1’, or

+ the service option group number of the requested service option is equal to an ACCT_SO_GRP entry in ACCT_SO_GRP_LIST and the corresponding ACCT_ENABLED entry is equal to ‘1’.

If the substate was entered with an origination indication, the mobile station shall send the Origination Message as an r-csch request.

[ . . . ]

2.6.3.7 Mobile Station Message Transmission Substate

In this substate, the mobile station sends a Data Burst Message or a Device Information Message. If the base station responds with an authentication request, the mobile station responds in this substate.

[ . . . ]

Upon entering the Mobile Station Message Transmission Substate, the mobile station shall transmit the message as follows:

The mobile station shall exit the Mobile Station Message Transmission Substate, shall enter either the Mobile Station Idle State or the System Determination Substate with an ACCT blocked indication, and should indicate to the user that the message transmission has terminated if all of the following conditions are true:

P_REV_IN_USEₛ is greater than six,

ACCT is enabled for the service option number associated with the data burst message, due to either of the following two conditions:

+ the service option number associated with the data burst message is equal to an ACCT_SO entry in ACCT_SO_LIST and the corresponding ACCT_ENABLED entry is equal to ‘1’, or

+ the service option group number of the service option associated with the data burst message is equal to an ACCT_SO_GRP entry in ACCT_SO_GRP_LIST and the corresponding ACCT_ENABLED entry is equal to ‘1’.

If the mobile station entered this substate with a message transmission indication, the mobile station shall transmit the Data Burst Message to the base station.

[ . . . ]

3.7.2.3.2.2 Access Parameters Message MSG_TAG: APM

| | Length |
|---|---|
| Field | (bits) |
| [ . . . ] | |
| PSIST_EMG | 0 or 3 |
| ACCT_INCL | 1 |
| ACCT_INCL_EMG | 0 or 1 |
| ACCT_AOC_BITMAP_IN | 0 or 1 |
| CL | |
| ACCT_SO_INCL | 0 or 1 |
| NUM_ACCT_SO | 0 or 4 |
| If ACCT_SO_INCL is equal to ‘1’, | |
| NUM_ACCT_SO + 1 occurrences of the | |
| following variable-field record: | |
| ACCT_AOC_BITMAP1 | 0 or 5 |
| ACCT_SO | 16 |
| ACCT_SO_GRP_INCL | 0 or 1 |
| NUM_ACCT_SO_GRP | 0 or 3 |
| If ACCT_SO_GRP_INCL is equal to ‘1’, | |
| NUM_ACCT_SO_GRP + 1 occurrences of | |
| the following variable-field record: | |
| ACCT_AOC_BITMAP2 | 0 or 5 |
| ACCT_SO_GRP | 5 |

ACCT_INCL—Access Control based on Call Type (ACCT) information included indicator.

If the base station enables ACCT for at least one service option, the base station shall set this field to ‘1’; otherwise, the base station shall set this field to ‘0’.

If the base station sets this field to ‘1’, then the base station shall also set at least one of ACCT_SO_INCL or ACCT_SO_GRP_INCL to ‘1’.

ACCT_INCL_EMG—Access Control based on Call Type (ACCT) includes emergency calls indicator.

If ACCT_INCL is set to ‘0’, the base station shall omit this field; otherwise, the base station shall include this field and set it as follows:

The base station shall set this field to ‘0’ if the mobile station is not to apply ACCT to a call that is recognized by the mobile station to be an emergency call; otherwise, the base station shall set this field to ‘1’.

ACCT_AOC_{—}

BITMAP_INCL—Access Control based on Call Type (ACCT) access overload class bitmap included indicator.

If ACCT_INCL is set to ‘0’, the base station shall omit this field; otherwise, the base station shall include this field and set it as follows:

The base station shall set this field to ‘0’ if all mobile stations are to apply ACCT regardless of their access overload classes; otherwise, the base station shall set this field to ‘1’ to indicate that the mobile station is to apply ACCT according to its access overload class.

ACCT_SO_INCL—-Access Control based on Call Type (ACCT) service option included indicator.

If ACCT_INCL is set to ‘0’, the base station shall omit this field; otherwise, the base station shall include this field and set it as follows:

The base station shall set this field to ‘1’ if at least one occurrence of the ACCT_SO field is included in this message; otherwise, the base station shall set this field to ‘0’.

NUM_ACCT_SO—Number of service options for Access Control based on Call Type (ACCT).

If ACCT_SO_INCL is not included, or is included and set to ‘0’, then the base station shall omit this field; otherwise, the base station shall include this field and set it to one less than the number of occurrences of the ACCT_SO field included in this message.

If ACCT_SO_INCL is included and set to ‘1’, then the base station shall include NUM_ACCT_SO+1 occurrences of the following variable-field record:

ACCT_AOC_BITMAP1—Access Control based on Call Type (ACCT) access overload class bitmap.

If ACCT_AOC_BITMAP_INCL is not included, or is included and set to ‘0’, then the base station shall omit this field; otherwise, the base station shall include this field and set it as follows:

This field consists of the subfields defined in Table 3.7.2.3.2.2-1.

Table 3.7.2.3.2.2-1. ACCT access overload class bitmap subfields.

| | Length | Subfield |
|---|---|---|
| Subfield | (bits) | Description |
| ACCOLC_0_1 | 1 | Access |
| | | overload |
| | | classes 0 and |
| | | 1 |
| ACCOLC_2_3 | 1 | Access |
| | | overload |
| | | classes 2 and |
| | | 3 |
| ACCOLC_4_5 | 1 | Access |
| | | overload |
| | | classes 4 and |
| | | 5 |
| ACCOLC_6_7 | 1 | Access |
| | | overload |
| | | classes 6 and |
| | | 7 |
| ACCOLC_8_9 | 1 | Access |
| | | overload |
| | | classes 8 and |
| | | 9 |

The base station shall set a subfield to ‘1’ to indicate that mobile stations having the corresponding access overload class are not permitted to perform access attempts using the associated service option ACCT_SO; otherwise, the base station shall set the subfield to ‘0’.

ACCT_SO Access Control based on Call Type (ACCT) service option number.

The base station shall set this field to the value of the service option number (as specified in [30]) that has ACCT enabled.

ACCT_SO_GRP_INCL Access Control based on Call Type (ACCT) service option group included indicator.

If ACCT_INCL is set to ‘0’, the base station shall omit this field; otherwise, the base station shall include this field and set it as follows:

The base station shall set this field to ‘1’ if at least one occurrence of the ACCT_SO GRP field is included in this message; otherwise, the base station shall set this field to ‘0’.

NUM_ACCT_SO_GRP Number of service option groups for Access Control based on Call Type (ACCT).

If ACCT_SO_GRP_INCL is not included, or is included and set to ‘0’, then the base station shall omit this field; otherwise, the base station shall include this field and set it to one less than the number of occurrences of the ACCT_SO_GRP field included in this message.

If ACCT_SO_GRP_INCL is included and set to ‘1’, then the base station shall include NUM_ACCT_SO_GRP+1 occurrences of the following variable-field record:

ACCT_AOC_BITMAP2—Access Control based on Call Type (ACCT) access overload class bitmap.

If ACCT_AOC_BITMAP_INCL is not included, or is included and set to ‘0’, then the base station shall omit this field; otherwise, the base station shall include this field and set it as follows:

This field consists of the subfields defined in Table 3.7.2.3.2.2-1. The base station shall set a subfield to ‘1’ to indicate that mobile stations having the corresponding access overload class are not permitted to perform access attempts using a service option specified by the associated ACCT_SO_GRP field; otherwise, the base station shall set the subfield to ‘0’.

ACCT_SO_GRP—Access Control based on Call Type (ACCT) service option group number.

The base station shall set this field to the value of the service option group number (as specified in [30]) whose members all have ACCT enabled.

[ . . . ]

3.7.2.3.2.33 Enhanced Access Parameters Message MSG_TAG: EAPM

| | Length |
|---|---|
| Field | (bits) |
| [ . . . ] | |
| RA_PARMS_LEN | 5 |
| [ . . . ] | |
| RESERVED | 0-7 (as |
| | needed) |
| ACCT_INCL | 1 |
| ACCT_INCL_EMG | 0 or 1 |
| ACCT_AOC_BITMAP_IN | 0 or 1 |
| CL | |
| ACCT_SO_INCL | 0 or 1 |
| NUM_ACCT_SO | 0 or 4 |
| If ACCT_SO_INCL is equal to ‘1’, | |
| NUM_ACCT_SO + 1 occurrences of the | |
| following variable-field record: | |
| ACCT_AOC_BITMAP1 | 0 or 5 |
| ACCT_SO | 16 |
| ACCT_SO_GRP_INCL | 0 or 1 |
| NUM_ACCT_SO_GRP | 0 or 3 |
| If ACCT_SO_GRP_INCL is equal to | |
| ‘1’, NUM_ACCT_SO_GRP + 1 | |
| occurrences of the following | |
| variable-field record: | |
| ACCT_AOC_BITMAP2 | 0 or 5 |
| ACCT_SO_GRP | 5 |

[ . . . ]

ACCT_INCL—Access Control based on Call Type (ACCT) information included indicator.

If the base station enables ACCT for at least one service option, the base station shall set this field to ‘1’; otherwise, the base station shall set this field to ‘0’.

If the base station sets this field to ‘1’, then the base station shall also set at least one of ACCT_SO_INCL or ACCT_SO_GRP_INCL to ‘1’.

ACCT_INCL_EMG—Access Control based on Call Type (ACCT) includes emergency calls indicator.

If ACCT_INCL is set to ‘0’, the base station shall omit this field; otherwise, the base station shall include this field and set it as follows:

The base station shall set this field to ‘0’ if the mobile station is not to apply ACCT to a call that is recognized by the mobile station to be an emergency call; otherwise, the base station shall set this field to ‘1’.

ACCT_AOC

BITMAP_INCL—Access Control based on Call Type (ACCT) access overload class bitmap included indicator.

If ACCT_INCL is set to ‘0’, the base station shall omit this field; otherwise, the base station shall include this field and set it as follows:

The base station shall set this field to ‘0’ if all mobile stations are to apply ACCT regardless of their access overload classes; otherwise, the base station shall set this field to ‘1’ to indicate that the mobile station is to apply ACCT according to its access overload class.

ACCT_SO_INCL—Access Control based on Call Type (ACCT) service option included indicator.

If ACCT_INCL is set to ‘0’, the base station shall omit this field; otherwise, the base station shall include this field and set it as follows:

The base station shall set this field to ‘1’ if at least one occurrence of the ACCT_SO field is included in this message; otherwise, the base station shall set this field to ‘0’.

NUM_ACCT_SO Number of service options for Access Control based on Call Type (ACCT).

If ACCT_SO_INCL is not included, or is included and set to ‘0’, then the base station shall omit this field; otherwise, the base station shall include this field and set it to one less than the number of occurrences of the ACCT_SO field included in this message. If ACCT_SO_INCL is included and set to ‘1’, then the base station shall include NUM_ACCT_SO+1 occurrences of the following variable-field record.

ACCT_AOC_BITMAP1—Access Control based on Call Type (ACCT) access overload class bitmap.

If ACCT_AOC_BITMAP_INCL is not included, or is included and set to ‘0’, then the base station shall omit this field; otherwise, the base station shall include this field and set it as follows:

This field consists of the subfields defined in Table 3.7.2.3.2.2-1.

The base station shall set a subfield to ‘1’ to indicate that mobile stations having the corresponding access overload class are not permitted to perform access attempts using the associated service option ACCT_SO; otherwise, the base station shall set the subfield to ‘0’.

ACCT SO Access Control based on Call Type (ACCT) service option number.

The base station shall set this field to the value of the service option number (as specified in [30]) that has ACCT enabled.

ACCT_SO_GRP_INCL—Access Control based on Call Type (ACCT) service option group included indicator.

If ACCT_INCL is set to ‘0’, the base station shall omit this field; otherwise, the base station shall include this field and set it as follows:

The base station shall set this field to ‘1’ if at least one occurrence of the ACCT_SO_GRP field is included in this message; otherwise, the base station shall set this field to ‘0’.

NUM_ACCT_SO_GRP—Number of service option groups for Access Control based on Call Type (ACCT).

If ACCT_SO_GRP_INCL is not included, or is included and set to ‘0’, then the base station shall omit this field; otherwise, the base station shall include this field and set it to one less than the number of occurrences of the ACCT_SO_GRP field included in this message.

If ACCT_SO_GRP_INCL is included and set to ‘1’, then the base station shall include NUM_ACCT_SO_GRP+1 occurrences of the following variable-field record:

ACCT_AOC_BITMAP2—Access Control based on Call Type (ACCT) access overload class bitmap.

If ACCT_AOC_BITMAP_INCL is not included, or is included and set to ‘0’, then the base station shall omit this field; otherwise, the base station shall include this field and set it as follows:

This field consists of the subfields defined in Table 3.7.2.3.2.2-1. The base station shall set a subfield to ‘1’ to indicate that mobile stations having the corresponding access overload class are not permitted to perform access attempts using a service option specified by the associated ACCT_SO_GRP field; otherwise, the base station shall set the subfield to ‘0’.

ACCT_SO_GRP Access Control based on Call Type (ACCT) service option group number.

The base station shall set this field to the value of the service option group number (as specified in [30]) whose members all have ACCT enabled.

[ . . . ]

Although only a few exemplary embodiments of this invention have been described in detail above, those skilled in the art will readily appreciate that many modifications are possible in the exemplary embodiments. Accordingly, all such modifications are intended to be included in the scope of this invention as defined in the following claims.

What is claimed is:

1. A method for selective call blocking in a communications network during an access overload condition:
detecting a plurality of simultaneous access requests from a plurality of mobile terminals, wherein the number of access requests exceeds capacity of a portion of the communications network, and
transmitting to the plurality of mobile terminals a message indicating a subset of the plurality of mobile terminals, the mobile terminals in the subset being prevented from accessing the network.

2. The method of claim 1 further comprising selecting the subset based on call type.

3. The method of claim 2 further comprising selecting the subset based on a classification of the mobile terminals.

4. The method of claim 3 further comprising determining the classification from unique identification numbers of the mobile terminals.

5. The method of claim 1 further comprising indicating in the message whether emergency calls are prevented from accessing the network.

6. A method for selective call blocking in a cell site during access overload conditions:
detecting at a base station a plurality of simultaneous access requests from a plurality of mobile terminals, the number of access requests exceeding the remaining capacity of the base station, and
dynamically adjusting and transmitting from the base station to all mobiles requesting service a subset of access overload classes until the number of mobiles requesting service falls to a level within the base station capacity.

7. The method of claim 6 wherein each mobile terminal has an access overload class associated therewith.

8. The method of claim 7 wherein each mobile having its access overload class in the subset received from the base station is blocked from accessing the base station.

9. The method of claim 8 wherein the step of adjusting involves randomly selecting elements of the subset from all the possible access overload classes.

10. A method for selective call blocking in a cell site during access overload conditions:
detecting at a base station a plurality of simultaneous access requests from a plurality of mobile terminals each requesting access for one of a plurality of call types, the number of access requests exceeding the remaining capacity of the base station, and
dynamically adjusting for each call type and transmitting from the base station to all mobiles requesting service a subset of access overload classes for each call type until the number of mobiles requesting service falls to a level within the base station capacity.

11. The method of claim 10 wherein each mobile terminal has an access overload class associated therewith.

12. The method of claim 11 wherein each mobile having its access overload class in the subset received from the base station is blocked from accessing the base station.

13. The method of claim 10 wherein the step of adjusting involves randomly selecting elements of the subset from all the possible access overload classes.

14. A method for selective call blocking in a cell site during access overload conditions:
detecting at a base station a plurality of simultaneous access requests from a plurality of mobile terminals each requesting access for one of a plurality of call types or service option groups, the number of access requests exceeding the remaining capacity of the base station, and
dynamically adjusting for each call type or service option group and transmitting from the base station to all mobiles requesting service a subset of access overload classes for each call type or service option group until the number of mobiles requesting service falls to a level within the base station capacity.

15. The method of claim 14 wherein each mobile terminal has an access overload class associated therewith.

16. The method of claim 15 wherein each mobile having its access overload class in the subset received from the base station is blocked from accessing the base station.

17. The method of claim 14 wherein the step of adjusting involves randomly selecting elements of the subset from all the possible access overload classes.

18. A node in a communications network, wherein the node has instructions for:
detecting a plurality of simultaneous access requests from a plurality of mobile terminals, wherein the number of access requests exceeds capacity of a portion of the communications network, and
transmitting to the plurality mobile terminals a message indicating a subset of the plurality of mobile terminals, the mobile terminals in the subset being prevented from accessing the network.

19. The node of claim 18 wherein the node has additional instructions for selecting the subset based on call type.

21. The node of claim 19 wherein the node has additional instructions for selecting the subset based on a classification of the mobile terminals.

22. The node of claim 20 wherein the node has additional instructions for determining the classification from unique identification numbers of the mobile terminals.

23. The node of claim 18 wherein the node has additional instructions for indicating in the message whether emergency calls are prevented from accessing the network.

24. A communications device comprising:
a processor,
a radio transceiver coupled to the processor,
a memory coupled to the processor, wherein the memory contains instructions for:
periodically receiving an access control message, and
determining whether the mobile communications device is subject to the access control message, if yes, then storing indicators in the memory for later use.

25. The communications device of claim 24 further comprising instructions for
receiving a send command to initiate a call session, and
determining from the indicators whether the send command is subject to the access control message, if yes, then stopping the call session.

26. The communications device of claim 24 wherein the determining instruction further comprises:
(a) reading a service indicated by the access control message,
(b) reading a class associated with the service,
(c) determining if the mobile communications device is a member of the class, if yes, then storing an indicator associated with the service,
(d) repeating steps a through c for each service contained in the access control message.

27. The communications device of claim 26 wherein step (c) further comprises determining if the mobile communications device is a member of the class using a unique identity number associated with the mobile communications device.

28. The communications device of claim 26 wherein the instructions further comprises:
receiving a send command to initiate a call session,
determining the service associated with the send command,
determining from indicators if the service associated with the send command is subject to the access control message, if yes, then stopping the call.

29. The communications device of claim 24 wherein the instructions further comprises reading at least one emergency parameter in the access control message.

30. The communications device of claim 28 wherein the instructions further comprises determining if the call session is an emergency call, if the call session is an emergency call, then determining whether the at least one emergency parameter indicates whether the emergency call is subject to the access control message, if yes, than stopping the call session.
